(19) United States
(12) Patent Application Publication
(10) Pub. No.: US 2026/0021666 A1
(43) Pub. Date: Jan. 22, 2026

(54) PRINTING APPARATUS

(71) Applicant: BROTHER KOGYO KABUSHIKI KAISHA, Nagoya (JP)

(72) Inventors: Yoshimitsu TANIGUCHI, Tajimi (JP); Gakuro KANAZAWA, Toyokawa (JP); Yuta ARAKAWA, Nagoya (JP)

(73) Assignee: BROTHER KOGYO KABUSHIKI KAISHA, Nagoya (JP)

(21) Appl. No.: 19/265,145

(22) Filed: Jul. 10, 2025

(30) Foreign Application Priority Data
Jul. 16, 2024 (JP) 2024-113652

(51) Int. Cl. B41J 11/00

(52) U.S. Cl. CPC B41J 11/006; B41J 11/0045

(57) ABSTRACT

A first guide includes a first guide surface and a second guide surface. A second guide is located below the first guide. The second guide includes a third guide surface. The first guide is movable between: a first position at which the first guide surface guides a sheet that is conveyed along a first conveyance path; and a second position at which the first guide is located at a lower position than the first guide at the first position. The second guide is movable between: a third position at which the third guide surface guides a sheet that is conveyed along a second conveyance path; and a fourth position at which the second conveyance path is opened. The first guide at the second position is located above the second guide at the fourth position.

### REFERENCE TO RELATED APPLICATIONS

This application claims priority from Japanese Patent Application No. 2024-113652 filed on Jul. 16, 2024. The entire content of the priority application is incorporated herein by reference.

### BACKGROUND ART

A printing apparatus configured to print an image on a sheet is known.

### SUMMARY

A printing apparatus includes a print head and a platen that supports a print medium during printing. The printing apparatus includes a path passing through a printing area and a reversing path for reversing a sheet. The printing area is located between the print head and the platen. The reversing path is located between a platen support member that supports the platen and a jam removal (jam processing) cover disposed on a side surface of the printing apparatus.

When a sheet is jammed in the reversing path, a user pivots the jam removal cover about a pivot shaft to expose the reversing path and removes the jammed sheet. When a sheet is jammed in a path passing through the printing area, the user opens the jam removal cover and then pivots the platen support member about the pivot shaft to access the path passing through the printing area. Thus, the user secures a space around the jammed area when performing the jam removal.

In view of the foregoing, an example of an object of this disclosure is to provide a printing apparatus configured to easily secure a space for a jam removal (jam processing) operation.

According to one aspect, this specification discloses a printing apparatus. The printing apparatus includes a housing, a first guide, and a second guide. The first guide is located in the housing. The first guide includes a first guide surface and a second guide surface. The first guide surface defines a first conveyance path. The second guide surface defines a second conveyance path located below the first conveyance path. The second guide is located below the first guide. The second guide includes a third guide surface defining the second conveyance path. The first guide is movable between: a first position at which the first guide surface guides a sheet that is conveyed along the first conveyance path; and a second position at which the first guide is located at a lower position than the first guide at the first position. Thus, the first conveyance path is opened. The second guide being movable between: a third position at which the third guide surface guides a sheet that is conveyed along the second conveyance path; and a fourth position at which the second conveyance path is opened. Thus, the second conveyance path is opened. The first guide at the second position is located above the second guide at the fourth position.

When a sheet is jammed in the first conveyance path, the second guide is movable to the fourth position and the first guide is movable to the second position. The jammed sheet is exposed downward from the first conveyance path. Further, when the sheet is jammed in the second conveyance path, the second guide moves to the fourth position, and the first guide moves to the second position, the jammed sheet is exposed in a state of hanging down from the second conveyance path. Further, when a sheet is jammed in the second conveyance path, the second guide is movable to the fourth position, and the first guide is supported by the jammed sheet, the jammed sheet is exposed downward from the second conveyance path. Thus, the first guide and the second guide do not take up the surrounding space, and a space for the user to insert his or her hand into the apparatus is also secured. Even when the first conveyance path and the second conveyance path is not accessible from above, the jam removal is performed, and the user easily accesses the jammed sheet exposed downward even when the sheet is jammed in either the first conveyance path or the second conveyance path.

### BRIEF DESCRIPTION OF DRAWINGS

FIG. 1 is an external perspective view of a multifunction peripheral (MFP) 10.

FIG. 2 is a schematic vertical cross-sectional view of a printer unit 11.

FIG. 3 is a perspective view of a side frame 53.

FIG. 4A is a perspective view of a left slider 116.

FIG. 4B is an inner side view of the left slider 116.

FIG. 4C is an outer side view of the left slider 116.

FIG. 5A is an external perspective view of a feed tray 20.

FIG. 5B is an inner side view of a left side wall of the feed tray 20.

FIGS. 6A and 6B are diagrams illustrating a state of the feed tray 20 and the left slider 116.

FIG. 7 is a vertical cross-sectional view illustrating a state where a first guide 54 is located at a first position.

FIGS. 8A, 8B and 8C are schematic views of a front pivoting member 105.

FIG. 9 is a diagram illustrating a state of the first guide 54 and the rear pivoting unit 74.

FIG. 10 is a diagram illustrating a state of the first guide 54 and the rear pivoting unit 74.

FIG. 11 is a diagram illustrating a state of the first guide 54 and the rear pivoting unit 74.

FIG. 12 is a diagram illustrating a state of the first guide 54 and the rear pivoting unit 74.

FIG. 13 is a diagram illustrating a state of the first guide 54 and the rear pivoting unit 74.

FIG. 14 is a schematic vertical cross-sectional view illustrating a printer unit 11b.

### DESCRIPTION

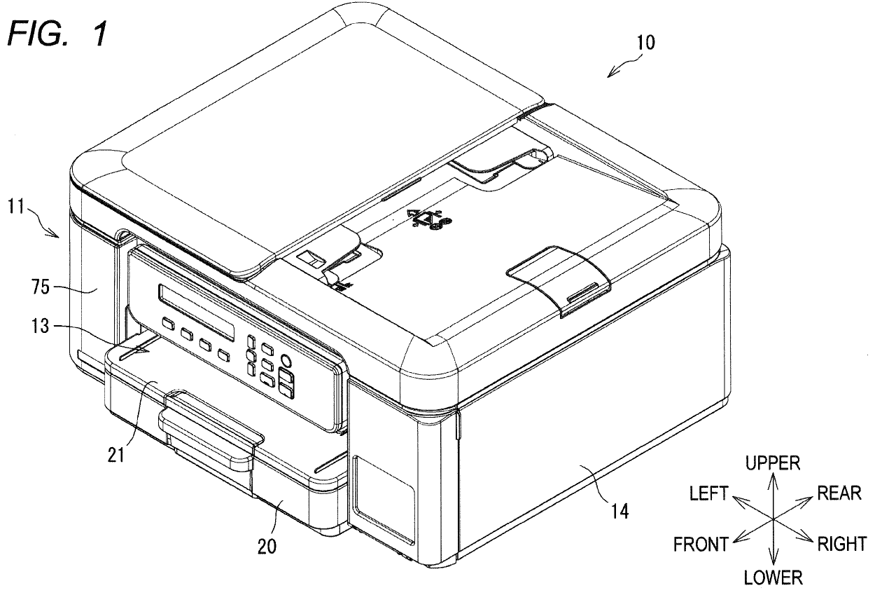

Hereinafter, an embodiment of the present disclosure will be described with reference to the drawings as appropriate. It is to be understood that the embodiment described below is merely an example of the present disclosure, and the embodiment of the present disclosure may be modified as appropriate without departing from the scope of the present disclosure. In the following description, an upper-lower direction is defined with reference to a state where a multifunction peripheral (MFP) 10 is installed in a usable manner as shown in FIG. 1, a front-rear direction is defined with a side on which an opening 13 is formed as a front side, and a left-right direction is defined when the MFP 10 is viewed from the front side.

An overall structure of the MFP 10 will be described. As shown in FIG. 1, the MFP 10 is formed in a thin rectangular parallelepiped shape, and a printer unit 11 is disposed in a lower portion of the MFP 10. The MFP 10 is an example of a printing apparatus. The MFP 10 has various functions such as a printing function, a facsimile function, and a copying function. The MFP 10 has a printing function of printing images on both sides of a sheet 12 by an inkjet method. The sheet 12 is an example of a sheet. The MFP 10 may be configured to print an image on the sheet 12 by a method other than the inkjet method, for example, an electrophotographic method.

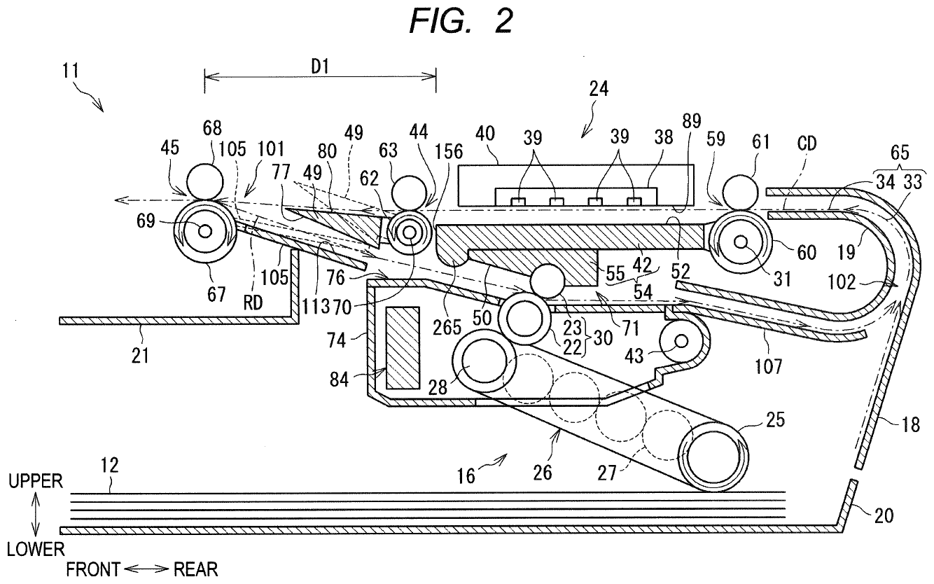

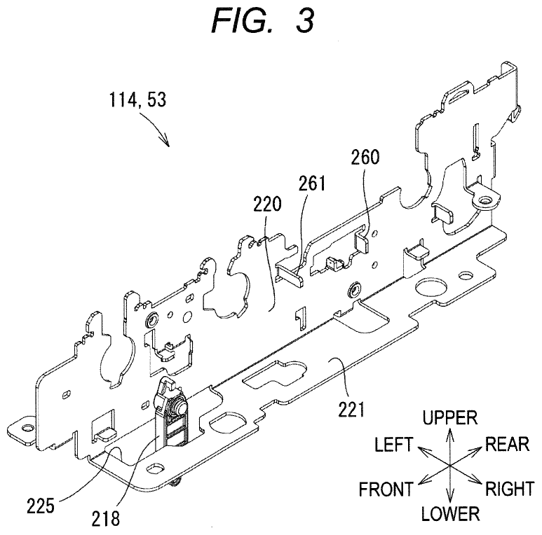

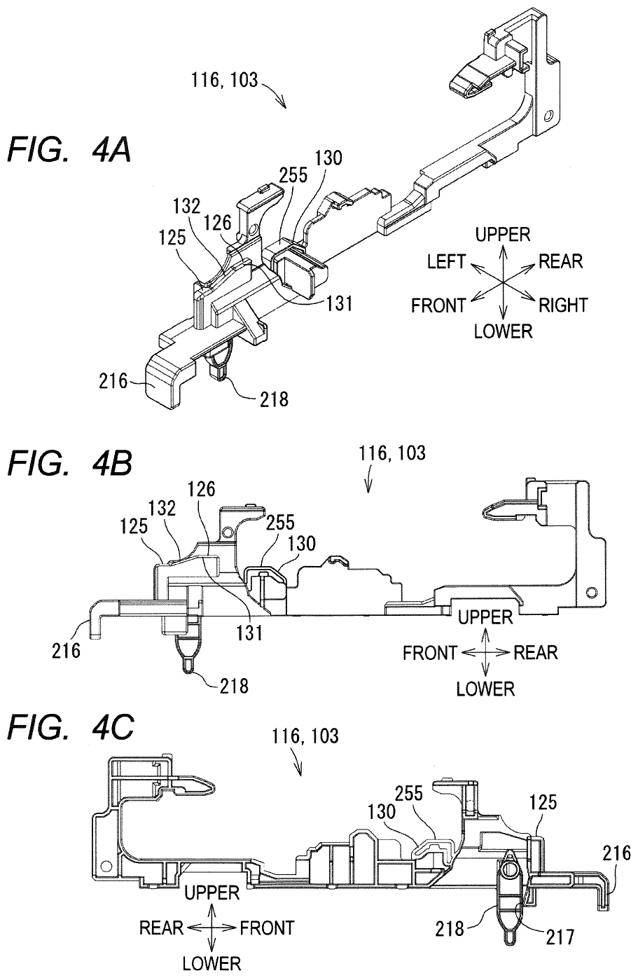

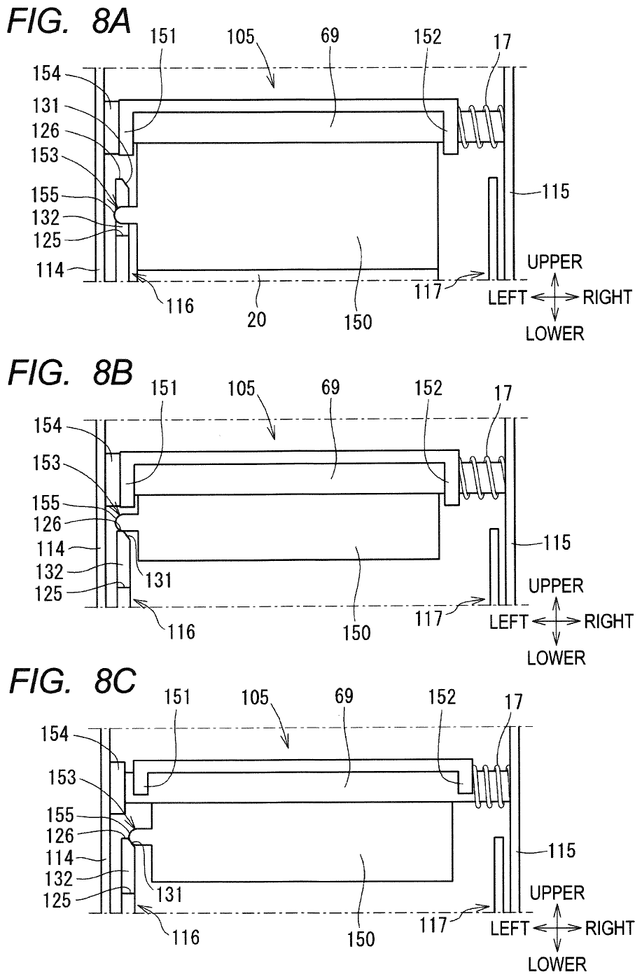

As shown in FIG. 1, the printer unit 11 includes a housing 14 with an opening 13 formed on a front surface 75. The housing 14 includes a first conveyance path 65 described later and a second conveyance path 71 shown in FIG. 2 disposed therein. The housing 14 is, for example, an exterior cover that houses each component of the printer unit 11 in its internal space. As shown in FIG. 2, the printer unit 11 includes a side frame 53 shown in FIG. 3, a slider 103 shown in FIGS. 4A to 4C, a feed tray 20, a discharge tray 21, a feeder 16, a print engine (printing unit) 24, a conveyance roller pair 59, a discharge roller pair 44, a reverse roller pair 45, a reverse roller pair 30, a flap 49, a first guide (first guide member) 54, a rear pivoting unit 74, a front pivoting member 105, and a first urging member (spring) 17 shown in FIG. 8A. The feed tray 20 is an example of a tray, the rear pivoting unit 74 is an example of a second guide (second guide member), and the front pivoting member 105 is an example of a third guide (third guide member).

As shown in FIG. 3, the side frame 53 is a sheet metal member that is long in the front-rear direction. The side frame 53 rotatably supports a shaft 31 of a conveyance roller 60, a shaft 70 of a discharge roller 62, and a shaft 69 of a reverse roller 67, which will be described later. The shaft 31 is an example of a first rotational shaft, and the shaft 69 is an example of a third rotational shaft. The side frame 53 includes a left side frame 114 located on the left side of the housing 14 and a right side frame 115 located on the right side shown in FIG. 8A. The left side frame 114 and the right side frame 115 are symmetrical with respect to a plane perpendicular to the left-right direction. In the present embodiment, the left side frame 114 will be described, and the description of the right side frame 115 will be omitted. The left side frame 114 has a vertical portion 220, a horizontal portion 221, and a lever member 218.

The vertical portion 220 extends in the upper-lower direction and the front-rear direction. The vertical portion 220 extends along a side surface of the housing 14. The vertical portion 220 has a first positioning portion 260 and a second positioning portion 261. The first positioning portion 260 and the second positioning portion 261 are portions obtained by bending the vertical portion 220 by 90 degrees inward in the left-right direction. The second positioning portion 261 is located forward of the first positioning portion 260.

The horizontal portion 221 is located at the lowermost portion of the left side frame 114. The horizontal portion 221 extends in the front-rear direction and the left-right direction. The horizontal portion 221 extends inward in the left-right direction from the lower end of the vertical portion 220. The lever member 218 is located near the front end of the left side frame 114 in the front-rear direction. The lever member 218 is longer in the upper-lower direction than in the front-rear direction. The lever member 218 is located at the surface of the vertical portion 220 facing rightward. The upper end of the lever member 218 is supported so as to pivot about an axis extending in the left-right direction. The lever member 218 hangs downward from the left side frame 114, and its lower end extends downward beyond the horizontal portion 221.

The horizontal portion 221 has a cutout 225. The cutout 225 is a through hole that accommodates pivoting of the lever member 218. The lever member 218 hangs downward from the support position within the cutout 225. The slider 103 is placed on the horizontal portion 221.

The slider 103 is movable between a seventh position (first slider position) and an eighth position (second slider position) forward of the seventh position due to insertion and removal of the feed tray 20. The slider 103 positions the first guide 54 at a particular position or releases the positioning. As shown in FIG. 4A, the slider 103 is a member that is long in the front-rear direction and narrow in the left-right direction. The slider 103 is a linear cam that moves in the front-rear direction within the housing 14 due to the insertion and removal of the feed tray 20. The slider 103 includes a left slider 116 located inside the left side frame 114 and a right slider 117 located inside the right side frame 115. The left slider 116 and the right slider 117 are substantially symmetrical with respect to a plane perpendicular to the left-right direction, but the shapes shown in FIGS. 8A to 8C are different between the left slider 116 and the right slider 117. In the present embodiment, the left slider 116 will be described in detail, and the description of the right slider 117 will be omitted. The left slider 116 is located on the horizontal portion 221 shown in FIG. 3. The left slider 116 slides between the seventh position and the eighth position on the horizontal portion 221 along the front-rear direction.

As shown in FIGS. 4A, 4B, and 4C, the left slider 116 has a first cam surface 255, a second cam surface 125, a third cam surface 126, a pressing portion 216 and a first receiving surface 217. The first cam surface 255 is located at the front of the approximate center of the left slider 116 in the front-rear direction. The first cam surface 255 is a horizontal surface facing upward. The first cam surface 255 has a first inclined surface 130 that slopes downward toward the rear. The first inclined surface 130 is a surface that is continuous with the rear end of the first cam surface 255. The first inclined surface 130 is an example of a guide portion (guide surface). In FIGS. 4A, 4B, and 4C, the lever member 218 located at the side frame 53 is illustrated in order to show the positional relationship between the lever member 218 and the left slider 116.

As shown in FIG. 4B, the second cam surface 125 is located near the front end of the left slider 116 in the front-rear direction. The second cam surface 125 is a horizontal surface facing upward. The second cam surface 125 is located above the first cam surface 255. The second cam surface 125 has a third inclined surface 132 that slopes upward toward the rear. The third inclined surface 132 is continuous with the rear end of the second cam surface 125. The third cam surface 126 is located rearward of the third inclined surface 132.

The third cam surface 126 is a horizontal surface facing upward. The third cam surface 126 is continuous with the rear end of the third inclined surface 132. As shown in FIG. 8A, the third cam surface 126 has a second inclined surface 131 that slopes downward toward the right. The second inclined surface 131 is continuous with the right end of the third cam surface 126. The third cam surface 126 is located forward of and above the first cam surface 255. The third cam surface 126 is located above the second cam surface 125.

The pressing portion 216 is located at the front end of the left slider 116. The pressing portion 216 is a surface that faces forward. As shown in FIG. 4C, the first receiving surface 217 is located near the front end of the left slider 116. The first receiving surface 217 is located forward of the lever member 218. The first receiving surface 217 is a surface that faces rearward. The first receiving surface 217 is located rearward of the pressing portion 216 and forward of the lever member 218. The first receiving surface 217 protrudes downward from the lower surface of the body of the slider 103. The lower surface of the body of the slider 103 is a surface that slides against the upper surface of the horizontal portion 221 of the side frame 53 when the slider 103 moves in the front-rear direction.

The feed tray 20 is inserted into and removed from the housing 14 through the opening 13. As shown in FIG. 2, the feed tray 20 supports the sheet 12. The discharge tray 21 is supported above the feed tray 20. The upper surface of the discharge tray 21 supports the sheet 12 on which an image is printed by the print engine 24 described later. The discharge tray 21 is inserted into and removed from the housing 14 through the opening 13 together with the feed tray 20.

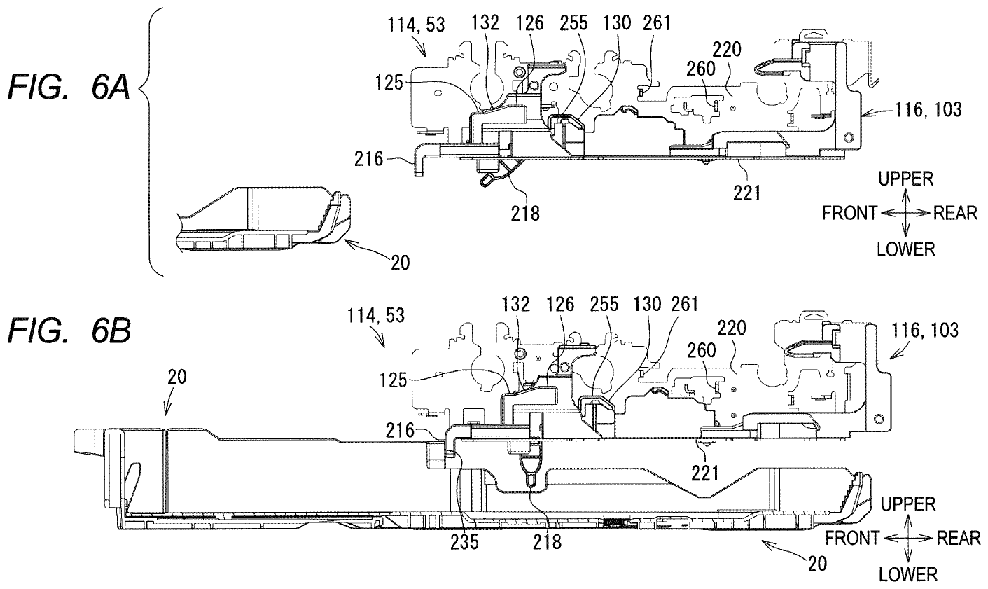

The feed tray 20 is movable by the user's manual operation between an insertion position where the feed tray 20 is inserted into the housing 14 shown in FIG. 2 and a removal position where the feed tray 20 is removed from the housing 14 shown in FIG. 6A. For example, plain paper of a size that is smaller than or equal to A4 size and larger than or equal to L size is used as the sheet 12. FIG. 6A is a diagram illustrating a state where the feed tray 20 is located at the removal position and the left slider 116 is located at the eighth position. FIG. 6B is a diagram illustrating a state where the feed tray 20 is located at the insertion position and the left slider 116 is located at the seventh position.

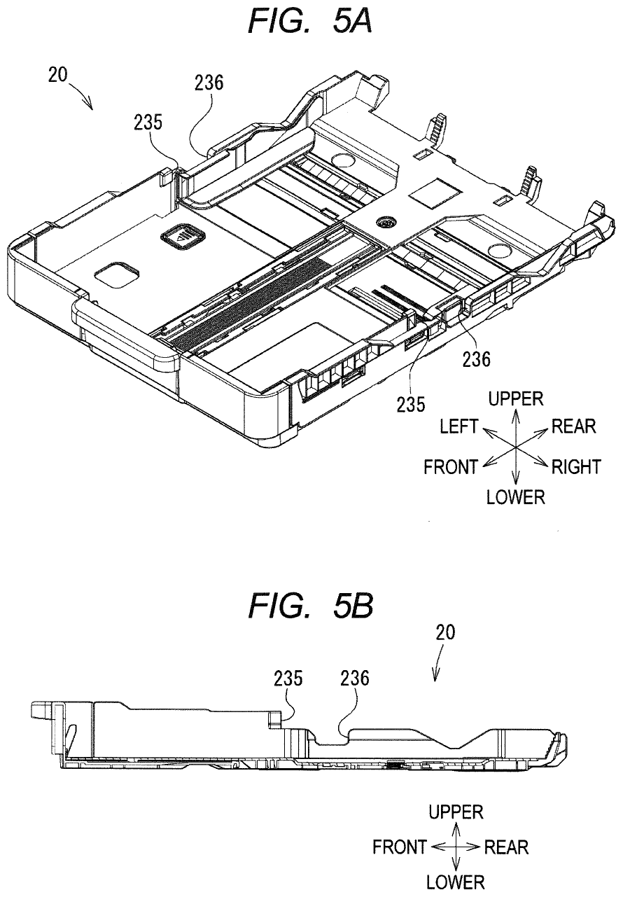

As shown in FIGS. 5A and 5B, the feed tray 20 has a first contact surface 235 and a second contact surface 236. The first contact surface 235 is located near the center of the feed tray 20 in the front-rear direction. The first contact surface 235 is a surface facing rearward. When the feed tray 20 moves from the removal position shown in FIG. 6A to the insertion position shown in FIG. 6B, the first contact surface 235 presses the pressing portion 216 of the slider 103. When the first contact surface 235 of the feed tray 20 presses the pressing portion 216 of the slider 103, the slider 103 moves from the eighth position to the seventh position. In this way, the slider 103 moves from the eighth position to the seventh position in conjunction with the insertion of the feed tray 20.

The second contact surface 236 is located near the center of the feed tray 20 in the front-rear direction, and is located rearward of the first contact surface 235. The second contact surface 236 is a surface that faces forward. The second contact surface 236 is located below the first contact surface 235. When the feed tray 20 moves from the insertion position to the removal position, the second contact surface 236 contacts the lever member 218 to cause the lever member 218 to pivot, and the lever member 218 contacts the first receiving surface 217 and presses the slider 103 forward, moving the slider 103 to the eighth position. In this way, the slider 103 moves from the seventh position to the eighth position in conjunction with the removal of the feed tray 20.

As shown in FIG. 2, the feeder 16 is located above the feed tray 20 in the insertion position. The feeder 16 is supported by the rear pivoting unit 74. The feeder 16 includes a feed roller 25, a feed arm 26, a drive transmission mechanism 27, and a support shaft 28. The feed roller 25 is supported at the distal end of the feed arm 26. The feed arm 26 is pivotable about the support shaft 28 located at the base end of the feed arm 26. In this way, the feed roller 25 contacts and separates from the sheet 12 supported by the feed tray 20.

The feed roller 25 is rotated by the driving force of a conveyance motor (not shown) transmitted by the drive transmission mechanism 27, which is composed of a plurality of meshing gears. As a result, among the sheets 12 supported by the feed tray 20, the uppermost sheet 12 in contact with the feed roller 25 is fed to the first conveyance path 65.

As shown in FIG. 2, the first conveyance path 65 extends from the rear end of the feed tray 20 in the internal space of the housing 14. The first conveyance path 65 includes a curved portion 33 and a straight portion 34. The curved portion 33 extends from the rear end of the feed tray 20 while curving upward, and is connected to the straight portion 34 at a position rearward of the conveyance roller pair 59 described later. The straight portion 34 extends in the front-rear direction from the connection position with the curved portion 33 to the reverse roller pair 45 described later.

The curved portion 33 is defined by an outer guide member 18 and an inner guide member 19 that face each other at a particular interval. The straight portion 34 is defined by a nozzle surface 89 of the print engine 24, a first guide surface 52 facing the nozzle surface 89, and an upper surface 80 of the flap 49 at a position where the print engine 24 is arranged. The sheet 12 supported by the feed tray 20 is fed to the curved portion 33 by the feed roller 25, and is conveyed from the curved portion 33 to the straight portion 34 along a conveyance direction CD.

The print engine 24 is located downstream of the conveyance roller 60 and upstream of the discharge roller 62 in the conveyance direction CD. The print engine 24 includes a carriage 40 and a print head 38. The carriage 40 is supported by two guide rails (not shown) arranged at a distance in the front-rear direction so as to reciprocate in the left-right direction. The left and right ends of the guide rails are supported by the left side frame 114 and the right side frame 115, respectively. The left side frame 114 is arranged to the left of the straight portion 34, and the right side frame 115 is arranged to the right of the straight portion 34.

The print head 38 is mounted on the carriage 40. Ink is supplied to the print head 38 from an ink cartridge (not shown). Nozzles 39 are formed on the lower surface of the print head 38. When the carriage 40 moves in the left-right direction, the print head 38 ejects ink droplets from the nozzles 39 toward the first guide 54. As a result, an image is printed on the sheet 12 that is conveyed in the conveyance direction CD along the straight portion 34 and supported by the first guide 54.

As shown in FIG. 2, the conveyance roller pair 59 is disposed upstream of the print engine 24 in the conveyance direction CD in the straight portion 34. The discharge roller pair 44 is disposed downstream of the print engine 24 in the conveyance direction CD in the straight portion 34. The reverse roller pair 45 is disposed downstream of the discharge roller pair 44 in the conveyance direction CD in the straight portion 34.

The conveyance roller pair 59 includes the conveyance roller 60 arranged below the straight portion 34 and a pinch roller 61 arranged above the straight portion 34 facing the conveyance roller 60. The discharge roller pair 44 includes the discharge roller 62 arranged below the straight portion 34 and a spur roller 63 arranged above the straight portion 34 facing the discharge roller 62. The reverse roller pair 45 includes the reverse roller 67 arranged below the straight portion 34 and a spur roller 68 arranged above the straight portion 34 facing the reverse roller 67.

The pinch roller 61 is urged toward the conveyance roller 60 by a coil spring (not shown), which allows the conveyance roller pair 59 to nip the sheet 12.

The conveyance roller 60, the discharge roller 62, and the reverse roller 67 rotate forward when a forward driving force of a motor (not shown) is transmitted, and rotate reversely when a reverse driving force is transmitted. The pinch roller 61 rotates by following rotation of the conveyance roller 60. The spur roller 63 rotates by following rotation of the discharge roller 62. The spur roller 68 rotates by following rotation of the reverse roller 67.

When the sheet 12 is nipped between the roller pairs 59, 44, and 45, and the rollers 60, 62, and 67 rotate forward, the nipped sheet 12 is conveyed in the conveyance direction CD. When the rollers 60, 62, and 67 rotate reversely, the nipped sheet 12 is conveyed in the direction opposite to the conveyance direction CD.

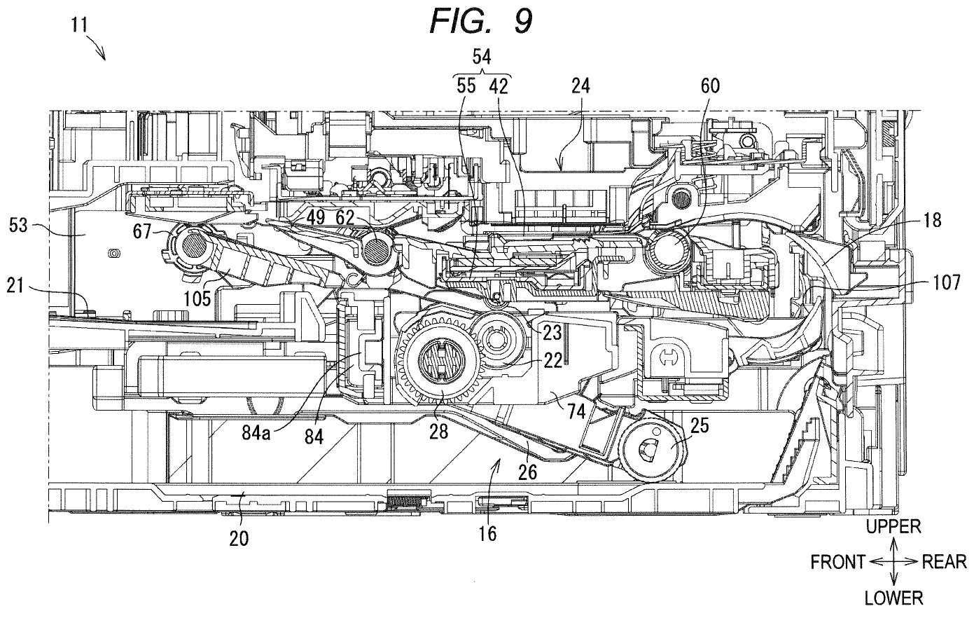

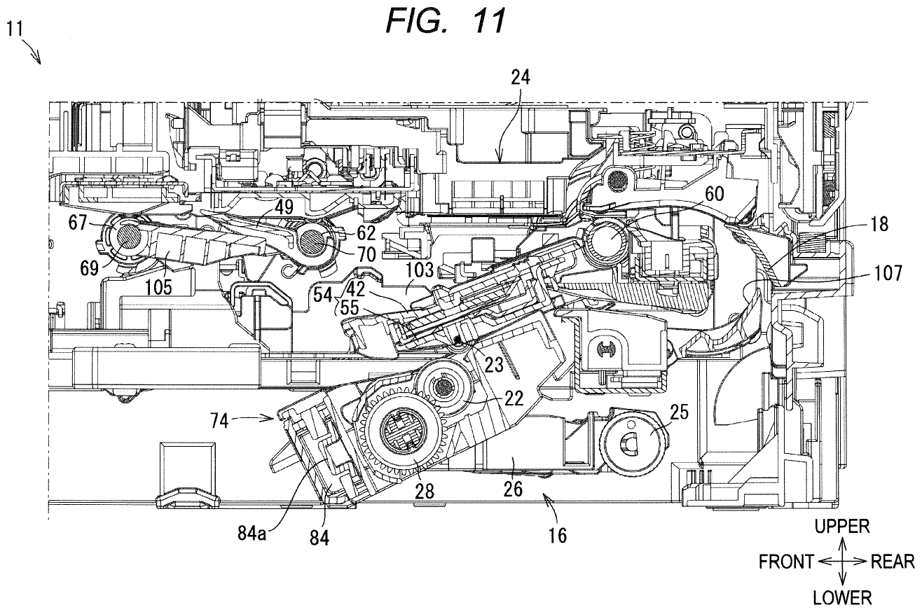

As shown in FIG. 2, the first guide 54 is located below the first conveyance path 65, downstream of the conveyance roller 60 and upstream of the discharge roller 62 in the conveyance direction CD. The first guide 54 includes a conveyance-path forming member 42 and a pressure receiving member 55. The conveyance-path forming member 42 has the first guide surface 52 that defines the first conveyance path 65. The first guide 54 is movable between a first position shown in FIG. 9 where the first guide surface 52 guides the sheet 12 conveyed through the first conveyance path 65, and a second position shown in FIG. 11 where the first guide 54 is located downward from the first position. When the first guide 54 is located at the first position, each of the conveyance-path forming member 42 and the pressure receiving member 55 is positioned. The conveyance-path forming member 42 includes a platen that supports the sheet 12.

The conveyance-path forming member 42 supports the sheet 12 conveyed through the first conveyance path 65. The conveyance-path forming member 42 is supported so as to be pivotable about the shaft 31 of the conveyance roller 60. The upstream end of the conveyance-path forming member 42 in the conveyance direction CD is supported by the shaft 31. The conveyance-path forming member 42 includes the first guide surface 52 and a contact portion 265. A separation distance D1 between a distal end 156 of the first guide 54 at the first position and the nip position of the reverse roller pair 45 in the front-rear direction is set to be 127 mm or less. The distal end 156 is a downstream end of the conveyance-path forming member 42 in the conveyance direction CD.

The first guide surface 52 is the surface of the first guide 54 at the first position that faces upward. The first guide surface 52 faces the nozzle surface 89 of the print engine 24 from below, with the straight portion 34 interposed therebetween.

The contact portion 265 is located at a pivotal distal end of the first guide 54. In a state where the first guide 54 is positioned at the first position, the contact portion 265 protrudes downward from a second guide surface 50.

The pressure receiving member 55 has a connecting portion (not shown), which is loosely fitted to a connected portion (not shown) of the conveyance-path forming member 42. Due to this loose fitting, the first guide surface 52 of the conveyance-path forming member 42 is displaceable downward relative to the pressure receiving member 55. The amount of this displacement is restricted within a certain range by the loose fitting. Thus, the pressure receiving member 55 pivots together with the conveyance-path forming member 42 as the first guide 54. The pressure receiving member 55 has the second guide surface 50 and a pinch roller 23. The pinch roller 23 is an example of a protrusion.

The second guide surface 50 is the surface of the first guide 54 at the first position that faces downward. The second guide surface 50 defines the second conveyance path 71 from above. The second conveyance path 71 is located below the first conveyance path 65. The pinch roller 23 will be described later.

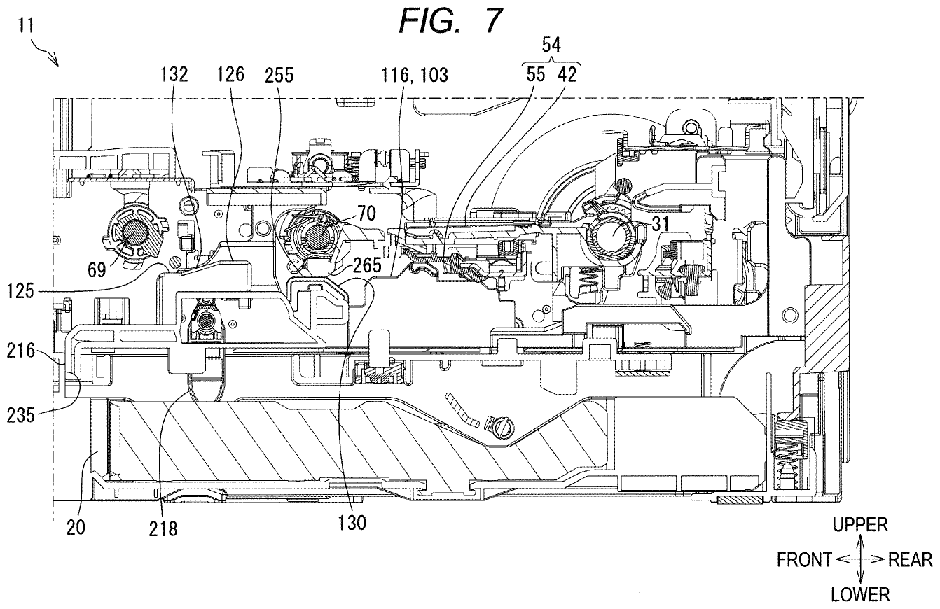

When the first guide 54 moves from the first position to the second position, the downstream end of the first guide 54 in the conveyance direction CD enters the second conveyance path 71. When the first guide 54 is located at the second position, the downstream end of the first guide 54 in the conveyance direction CD is located at the lowest position. The first guide 54 at the second position is supported by the rear pivoting unit 74 at a fourth position, which will be described later. As shown in FIG. 7, when the slider 103 is located at the seventh position, the contact portion 265 is supported by the first cam surface 255 and the first guide 54 is located at the first position. When the slider 103 moves from the seventh position to the eighth position, the support of the contact portion 265 by the first cam surface 255 is released, and the first guide 54 separates from the first position.

As shown in FIG. 2, the second conveyance path 71 is a path that passes below the straight portion 34 and above the feed roller 25. The second conveyance path 71 is located on the opposite side of the straight portion 34 in the upper-lower direction with respect to the discharge roller 62. The second conveyance path 71 is a path that branches from the straight portion 34 at a downstream position 101 which is located upstream of the reverse roller pair 45 in the conveyance direction CD and downstream of the discharge roller pair 44 in the conveyance direction CD. In other words, the second conveyance path 71 branches from the straight portion 34 toward the side of the first guide 54 in the upper-lower direction. The second conveyance path 71 is a path that merges with the curved portion 33 at an upstream position 102 which is upstream of the conveyance roller pair 59 in the conveyance direction CD. The second conveyance path 71 is defined by a guide surface 77 of the flap 49 described later, an upper surface 113 of the front pivoting member 105, the second guide surface 50, and a third guide surface 76. In the second conveyance path 71, the sheet 12 is conveyed in a reverse conveyance direction RD. The reverse conveyance direction RD is a direction from the downstream position 101 to the upstream position 102 in the second conveyance path 71, and is indicated by a single-dot chain line in FIG. 2.

As shown in FIG. 2, the reverse roller pair 30 is located on the second conveyance path 71. The reverse roller pair 30 is located rearward of the discharge roller pair 44 in the front-rear direction. The reverse roller pair 30 includes a re-conveyance roller 22 disposed below the second conveyance path 71, and the pinch roller 23 disposed above the second conveyance path 71 so as to face the re-conveyance roller 22. The re-conveyance roller 22 is disposed at the rear pivoting unit 74 described later. The pinch roller 23 is disposed at the first guide 54 described above. The re-conveyance roller 22 is driven by a motor (not shown). The pinch roller 23 is supported by the first guide 54, and a part of the outer circumferential surface of the pinch roller 23 protrudes from the second guide surface 50. The pinch roller 23 rotates by following rotation of the re-conveyance roller 22. The re-conveyance roller 22 is supported by the rear pivoting unit 74, and a part of the outer circumferential surface of the re-conveyance roller 22 protrudes from the third guide surface 76. The re-conveyance roller 22 nips the sheet 12 together with the pinch roller 23. The re-conveyance roller 22 rotates forward regardless of whether a driving force of the forward rotation or reverse rotation of the motor is transmitted. When the re-conveyance roller 22 rotates forward while the sheet 12 is nipped by the reverse roller pair 30, the nipped sheet 12 is conveyed in the reverse conveyance direction RD.

As shown in FIG. 2, the flap 49 is located between the discharge roller pair 44 and the reverse roller pair 45 on the straight portion 34. When the sheet 12 is conveyed along the straight portion 34 and passes the upper surface 80, the flap 49 changes its position from a first state indicated by a solid line in FIG. 2 to a second state indicated by a broken line in FIG. 2, and guides the sheet 12 to the second conveyance path 71 when the reverse roller 67 rotates in the reverse direction and conveys the sheet 12 in the reverse direction. When the flap 49 is located in the first state, the flap 49 guides the sheet 12 downstream in the conveyance direction CD along the first conveyance path 65.

In the first state, the flap 49 is pivoted in the counterclockwise direction in FIG. 2 about the shaft 70 of the discharge roller 62. In the second state, the flap 49 is pivoted in the clockwise direction in FIG. 2 about the shaft 70. The flap 49 has the upper surface 80 and the guide surface 77. The upper surface 80 is the surface of the flap 49 that faces upward in the first state. The guide surface 77 is the surface that guides the sheet 12 to the second conveyance path 71, and crosses the first conveyance path 65 when the flap 49 is in the second state.

As shown in FIG. 2, the rear pivoting unit 74 is located below the second conveyance path 71 and above the feed tray 20 located at the insertion position. The rear pivoting unit 74 is supported so as to be pivotable about a shaft 43 located below the shaft 31. The shaft 43 is parallel to the shaft 31. The shaft 43 is an example of a second pivot shaft. The shaft 43 supports the downstream end of the rear pivoting unit 74 in the reverse conveyance direction RD.

The rear pivoting unit 74 is movable between a third position where the third guide surface 76 guides the sheet 12 conveyed along the second conveyance path 71, and a fourth position shown in FIG. 11 where the second conveyance path 71 is opened. The third position is the position where the rear pivoting unit 74 is pivoted most clockwise about the shaft 43 in FIG. 2. The fourth position is the position where the rear pivoting unit 74 is pivoted most counterclockwise about the shaft 43.

The rear pivoting unit 74 pivotably supports the feed arm 26. The rotational driving force of the re-conveyance roller 22 is transmitted to the feed roller 25 by the drive transmission mechanism 27 of the feed arm 26.

The rear pivoting unit 74 includes the re-conveyance roller 22, the third guide surface 76, an engagement portion 84, and a second urging member (not shown). The engagement portion 84 is an example of a lever. The third guide surface 76 is the surface of the rear pivoting unit 74 that faces upward at the third position. When the rear pivoting unit 74 is located at the third position, the third guide surface 76 faces the second guide surface 50 of the first guide 54 from below, with the second conveyance path 71 interposed therebetween.

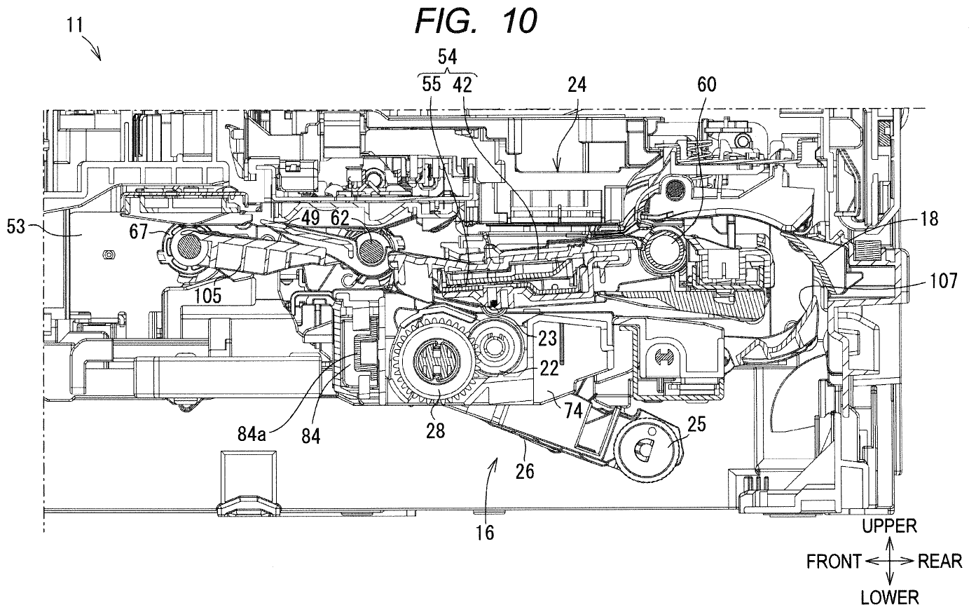

The engagement portion 84 is located at the upstream end of the rear pivoting unit 74 in the reverse conveyance direction RD. The engagement portion 84 includes a slide portion 84a shown in FIGS. 9 and 10. The slide portion 84a is movable (slidable) in the left-right direction between a fifth position where the slide portion 84a engages with the housing 14 and a sixth position where the slide portion 84a is disengaged from the housing 14. The slide portion 84a of the engagement portion 84 protrudes from the rear pivoting unit 74 and engages with the housing 14. With this engagement, the rear pivoting unit 74 is positioned at the third position. The second urging member (not shown) urges the slide portion 84a toward the fifth position (engagement position). The slide portion 84a is movable to the sixth position against the urging force of the second urging member (not shown) by the user's manual operation.

As shown in FIG. 2, the front pivoting member 105 is located upstream of the rear pivoting unit 74 in the reverse conveyance direction RD. The front pivoting member 105 is supported so as to be pivotable about the shaft 69 of the reverse roller 67. The shaft 69 is an example of a third pivot shaft. The front pivoting member 105 is pivotable between a ninth position (guide position) where the front pivoting member 105 guides the sheet 12 conveyed along the second conveyance path 71, and a tenth position (enter position) where the front pivoting member 105 is pivoted counterclockwise from the ninth position in FIG. 2 and the downstream end in the reverse conveyance direction RD enters the second conveyance path 71. The front pivoting member 105 is supported from below by the discharge tray 21 inserted in the housing 14 and is positioned at the ninth position. The front pivoting member 105 is supported from below by the slider 103 located at the eighth position, and the front pivoting member 105 is positioned at the tenth position. The ninth position is indicated by a solid line in FIG. 2, and the tenth position is indicated by a broken line.

FIG. 8A is a schematic view of the front pivoting member 105 at the ninth position as viewed from the front. FIG. 8B is a schematic view of the front pivoting member 105 at the tenth position as viewed from the front. FIG. 8C is a schematic view illustrating a state where the front pivoting member 105 has moved to the right. As shown in FIG. 8A, the front pivoting member 105 includes a main body 150, a left support portion 151, a right support portion 152, and a protruding portion 153. The main body 150 is a portion that extends downstream in the reverse conveyance direction RD along the second conveyance path 71 when the front pivoting member 105 is located at the ninth position. The main body 150 supports the sheet 12 conveyed along the second conveyance path 71.

The left support portion 151 is located on the left side of the front end of the front pivoting member 105. The right support portion 152 is located on the right side of the front end of the front pivoting member 105. The shaft 69 is inserted through the left support portion 151 and the right support portion 152. The first urging member 17 is located between the right support portion 152 and the right side frame 115. As a result, the front pivoting member 105 is urged leftward relative to the right side frame 115. The front pivoting member 105, which is urged leftward by the first urging member 17 and is located at the ninth position, contacts a contact piece 154 fixed to the left end of the shaft 69 at the left support portion 151. The front pivoting member 105 at the ninth position is movable rightward against the urging force of the first urging member 17.

The protruding portion 153 protrudes leftward from the surface of the main body 150 facing leftward. The protruding portion 153 has a hemispherical distal end 155. As shown in FIG. 8A, when the front pivoting member 105 is located at the ninth position, the protruding portion 153 is located above the second cam surface 125. In other words, the protruding portion 153 is not supported by the second cam surface 125. As shown in FIG. 8B, when the front pivoting member 105 is located at the tenth position, the protruding portion 153 is located on the third cam surface 126.

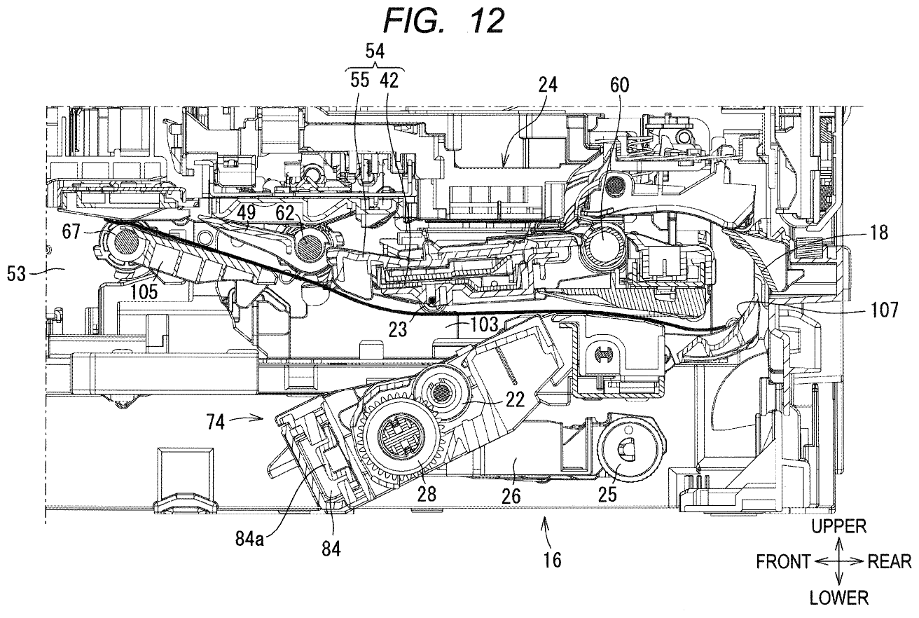

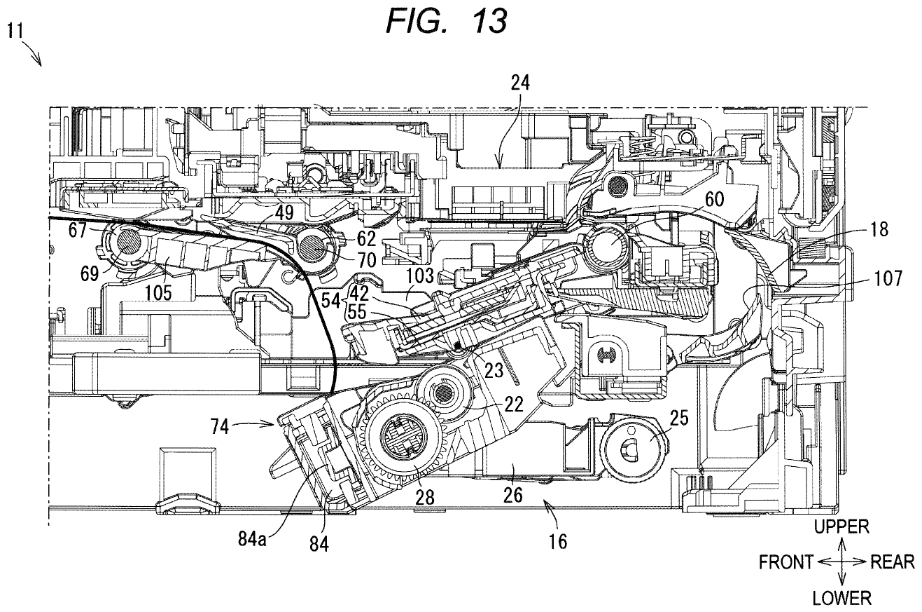

Jam removal will be described. When a jam occurs, jam removal is performed at the printer unit 11 as follows. When a jam occurs, the slider 103 is located at the seventh position, the first guide 54 is located at the first position, the rear pivoting unit 74 is located at the third position, and the front pivoting member 105 is located at the ninth position shown in FIG. 2 and FIG. 9. FIG. 9 is a diagram illustrating a state where the first guide 54 is located at the first position and the rear pivoting unit 74 is located at the third position. FIG. 10 is a diagram illustrating a state where the first guide 54 is released from the first position and the rear pivoting unit 74 is located at the third position. FIG. 11 is a diagram illustrating a state where the first guide 54 is located at the second position and the rear pivoting unit 74 is located at the fourth position. FIG. 12 is a diagram illustrating the first guide 54 and the rear pivoting unit 74 when the sheet 12 is jammed in a state of being stretched between the reverse roller pair 45 and the rear guide portion 107. FIG. 13 is a diagram illustrating a state where the sheet 12 is jammed in the second conveyance path 71 and the leading end of the sheet 12 is hanging down, together with the first guide 54 and the rear pivoting unit 74.

(1) The feed tray 20 and the discharge tray 21 are removed. More specifically, when the slider 103 slides from the seventh position to the eighth position in conjunction with the feed tray 20 being pulled out from the insertion position to the removal position, the first guide 54 is released from its first position. Specifically, as the slider 103 moves from the seventh position to the eighth position, the contact portion 265 moves from above the first cam surface 255 to the lower end of the first inclined surface 130. As a result, the first guide 54 is movable from the first position to the second position by its own weight. At this time, as shown in FIG. 10, the rear pivoting unit 74 is maintained at the third position due to the engagement between the engagement portion 84 (specifically, the slide portion 84a) and the housing 14.

As shown in FIG. 2 and FIG. 4, when the discharge tray 21 is removed together with the feed tray 20, the slider 103 moves from the seventh position to the eighth position, and the distal end 155 of the front pivoting member 105 contacts the third inclined surface 132 from a position above the second cam surface 125, and then the distal end 155 slides on the third inclined surface 132 and moves onto the third cam surface 126. As a result, as shown in FIG. 10, the front pivoting member 105 moves from the ninth position to the tenth position, which increases the space below the front pivoting member 105 and near the discharge roller 62.

(2) The rear pivoting unit 74 is moved from the third position to the fourth position. More specifically, when a user inserts his or her hand through the opening 13 and moves the engagement portion 84 (specifically, the slide portion 84a) of the rear pivoting unit 74 from the fifth position to the sixth position to disengage the engagement portion 84 from the housing 14, as shown in FIG. 11, the rear pivoting unit 74 pivots about the shaft 43 by its own weight and moves from the third position to the fourth position. As shown in FIG. 11, when a jam occurs in the first conveyance path 65, the first guide 54 pivots about the shaft 31 by its own weight and moves from the first position to the second position, and the first conveyance path 65 is opened. At this time, the first guide 54 is supported by the rear pivoting unit 74 at the fourth position. Thus, the user accesses and removes the sheet 12 jammed in the first conveyance path 65. The front pivoting member 105 at this time is located at the tenth position.

When a jam occurs in the second conveyance path 71, the sheet 12 is jammed in the second conveyance path 71. At this time, as shown in FIG. 12, if the leading end of the sheet 12 is located rearward of the rear guide portion 107, the sheet 12 is stretched across the reverse roller pair 45 and the rear guide portion 107. At this time, the first guide 54 is supported by the sheet 12 at a position intermediate between the first position and the second position. The first guide 54 is supported by the sheet 12 jammed in the second conveyance path 71, and the rear pivoting unit 74 moves to the fourth position, and the second conveyance path 71 is opened. At this time, the front pivoting member 105 is located at the tenth position.

As shown in FIG. 13, when a jam occurs in the second conveyance path 71 and the leading end of the sheet 12 is located forward of the rear guide portion 107 due to a reason such as a relatively small sheet 12, the trailing end side of the sheet 12 is nipped by the reverse roller pair 45 and the leading end side hangs downward. In this case, the first guide 54 moves from the first position to the second position by its own weight and is supported by the rear pivoting unit 74 at the fourth position. In this way, the first conveyance path 65 and the second conveyance path 71 are opened. At this time, the front pivoting member 105 is located at the tenth position. The user easily finds the sheet 12 hanging downward from the second conveyance path 71 through the opening 13 and removes the sheet 12.

When the sheet 12 is jammed in the second conveyance path 71, the user inserts his or her hand through the opening 13 to remove the sheet 12. At this time, the front pivoting member 105 has moved from the ninth position to the tenth position so that a space is secured below the front pivoting member 105. Thus, the second conveyance path 71 becomes narrow and it may be difficult to pull out the jammed sheet 12. In this case, the user pulls the sheet 12 strongly downward to release the front pivoting member 105 from the tenth position.

Specifically, the operation is as follows. The front pivoting member 105 at the tenth position receives a downward load when the sheet 12 at the second conveyance path 71 is pulled downward. At this time, as shown in FIG. 8B and FIG. 8C, the main body 150 moves rightward against the urging force of the first urging member 17. As a result, the distal end 155 is guided to the second inclined surface 131 and moves downward while sliding on the second inclined surface 131. As shown in FIG. 8C, when the front pivoting member 105 receives a further downward load, the distal end 155 leaves the second inclined surface 131 and moves downward while sliding on the surface of the left slider 116 facing rightward.

(3) The rear pivoting unit 74 is returned from the fourth position to the third position. More specifically, after the jam removal, the user returns the rear pivoting unit 74 from the fourth position to the third position, causing the engagement portion 84 (specifically, the slide portion 84a) to engage with the housing 14. At this time, the pinch roller 23 is pressed by the re-conveyance roller 22. As a result, the first guide 54 is pushed up from the second position to a position close to the first position shown in FIG. 10.

(4) The feed tray 20 and the discharge tray 21 are inserted. In conjunction with the feed tray 20 being pushed into the opening 13, the slider 103 slides from the eighth position to the seventh position. Specifically, as the slider 103 moves from the eighth position to the seventh position, the contact portion 265 slides on the first inclined surface 130 and moves onto the first cam surface 255. As a result, as shown in FIG. 9, the first guide 54 pushed up by the re-conveyance roller 22 is positioned at the first position. As shown in FIG. 8A, when the discharge tray 21 and the feed tray 20 are inserted, the front pivoting member 105 is supported by the discharge tray 21 at the height of the ninth position, and is urged leftward by the urging force of the first urging member 17 so that the protruding portion 153 is located above the second cam surface 125.

Advantageous effects of the embodiment will be described. When the sheet 12 is jammed in the first conveyance path 65, the rear pivoting unit 74 is movable to the fourth position and the first guide 54 is movable to the second position. At this time, the first guide 54 is placed on (overlaps) the rear pivoting unit 74. Thus, the first guide 54 and the rear pivoting unit 74 are compactly stored without taking up the surrounding space. The jammed sheet 12 is exposed downward from the first conveyance path 65. Further, when a relatively small-sized sheet 12 such as an L-sized sheet is jammed in the second conveyance path 71, the rear pivoting unit 74 moves to the fourth position and the first guide 54 moves to the second position so that the leading end of the jammed sheet 12 hangs downward from the second conveyance path 71. In this case, the user easily finds the sheet 12 through the opening 13. The first guide 54 is placed on (overlaps) the rear pivoting unit 74. Further, when a relatively large-sized sheet 12 such as an A4-sized sheet is jammed in the second conveyance path 71, the sheet 12 may be stretched across the reverse roller pair 45 and the rear guide portion 107. At this time, the rear pivoting unit 74 moves to the fourth position and the first guide 54 is supported by the jammed sheet 12 so that the jammed sheet 12 is exposed downward from the second conveyance path 71. A space is also secured for the user to insert his or her hand through the opening 13 to handle the jam. A jam is removed even when the first conveyance path 65 and the second conveyance path 71 are not accessible from above, and the user easily accesses the jammed sheet 12 exposed downward, regardless of whether the sheet 12 is jammed in the first conveyance path 65 or the second conveyance path 71.

When the first guide 54 is in a state of being movable from the first position, the first guide 54 may be supported on the rear pivoting unit 74. When the rear pivoting unit 74 is at the fourth position, the first guide 54 descends downward by its own weight and is located at the second position, and thus the first conveyance path 65 and the second conveyance path 71 are exposed downward. This allows the user to insert his or her hand through the opening 13 and perform jam removal by easily finding the location where the sheet 12 is jammed.

The first guide 54 and the rear pivoting unit 74 are opened toward the opening 13, which allows the user to easily find the location where the sheet 12 is jammed. A compact device that does not require a large space around the device is realized.

When the first guide 54 is released from the first position, damage due to collision and abrasion of the second guide surface 50 of the first guide 54 against the third guide surface 76 of the rear pivoting unit 74 is prevented.

The pinch roller 23 is rotatable, which prevents damage and abrasion of the second guide surface 50 or the third guide surface 76 due to friction with the pinch roller 23.

The engagement portion 84 (specifically, a sliding operation of the slide portion 84a) allows the user to easily switch the rear pivoting unit 74 to a state where the rear pivoting unit 74 is movable from the third position to the fourth position, which facilitates jam removal.

The first guide 54 is accurately positioned at the first position by the movement of the slider 103.

The first guide 54 is moved from the first position to the second position by a simple operation of pulling out the feed tray 20.

When the feed tray 20 is pulled out, the front pivoting member 105 at the ninth position enters the second conveyance path 71 and moves to the tenth position, thereby increasing the space below the front pivoting member 105. This allows the user to easily access the first conveyance path 65 and the second conveyance path 71 when removing the jammed sheet 12.

When a downward load is applied to the front pivoting member 105 at the tenth position, the front pivoting member 105 moves rightward along the shaft 69 against the urging force of the first urging member 17 and separates from the slider 103. As a result, the front pivoting member 105 is movable from the tenth position to the ninth position. Thus, even if the sheet 12 is jammed in the second conveyance path 71 and is caught in the front pivoting member 105, the jammed sheet 12 is reliably removed simply by pulling the sheet 12 downward.

Even if the sheet 12 is the smallest L-sized sheet, the jammed sheet 12 is easily removed.

While the disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

A first modification will be described. In the above-mentioned embodiment, when the first guide 54 is moved from the second position to the first position, the rear pivoting unit 74 is moved from the fourth position to the third position to pivotally move the first guide 54 from the second position to a position close to the first position, and then the slider 103 is moved from the eighth position to the seventh position by inserting the feed tray 20, thereby performing an operation of positioning the first guide 54 at the first position. However, the movement of the first guide 54 from the second position to the first position is not limited to this.

The first guide 54 may be moved from the second position to the first position in conjunction with the movement of the slider 103 from the eighth position to the seventh position. When the first guide 54 is located at the second position, the contact portion 265 is located on the first inclined surface 130 of the left slider 116, slides on the first inclined surface 130 and moves onto the first cam surface 255 in conjunction with the movement of the slider 103 from the eighth position to the seventh position. In this way, the first guide 54 is positioned at the first position. The first inclined surface 130 is an example of a guide portion (guide surface).

Even when the first guide is located at the second position, the first guide moves to the first position by the movement of the slider, without requiring an operation to pivotally move the rear pivoting unit 74.

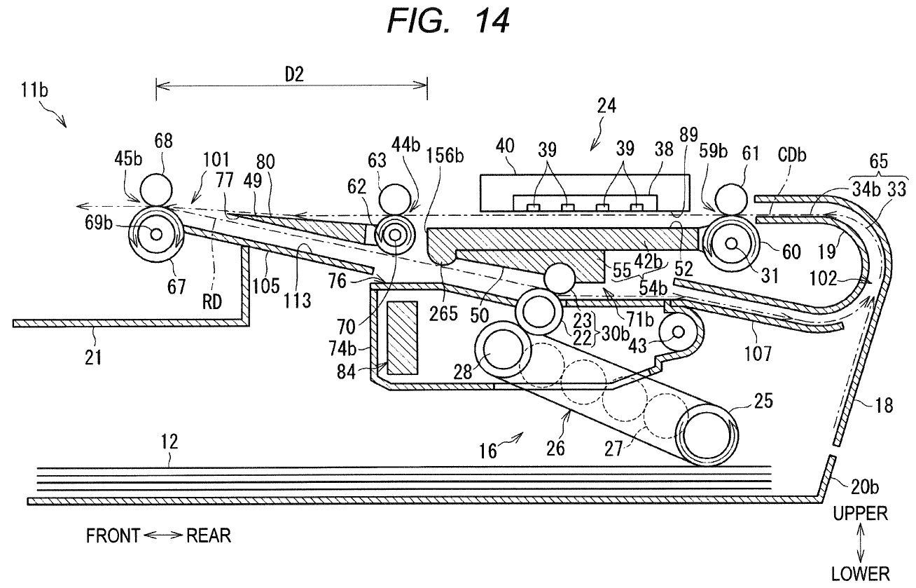

A second modification will be described. In the above-described embodiment, as an example, the separation distance D1 between the distal end 156 on the downstream side in the conveyance direction CD of the conveyance-path forming member 42 of the first guide 54 at the first position and the nip position of the reverse roller pair 45 in the front-rear direction is set to 127 mm or less. However, the present disclosure is not limited to this configuration. As shown in FIG. 14, a separation distance D2 between a distal end 156b of a conveyance-path forming member 42b and the nip position of a reverse roller pair 45b may be greater than 127 mm. In a printer unit 11b, the sheet 12 used for image printing may be, for example, an A3-sized sheet, which is larger than A4 size.

The printer unit 11b is longer in the front-rear direction than the printer unit 11 of the MFP 10 according to the embodiment. That is, a straight portion 34b and a second conveyance path 71b are longer in the front-rear direction than those of the printer unit 11. Thus, a first guide 54b, a rear pivoting unit 74b, and a feed tray 20b are longer in the front-rear direction than the first guide 54, the rear pivoting unit 74, and the feed tray 20 of the above-described embodiment. The distance between a conveyance roller pair 59b and a discharge roller pair 44b is longer in the front-rear direction than the distance between the conveyance roller pair 59 and the discharge roller pair 44 of the MFP 10 according to the above-described embodiment.

In the printer unit 11b according to the second modification, the separation distance D2 between the downstream distal end 156b of the conveyance-path forming member 42b in a conveyance direction CDb of the first guide 54b at the first position and the nip position of the reverse roller pair 45b in the front-rear direction is set to be greater than 127 mm and less than or equal to 297 mm. When the rear pivoting unit 74b is located at the third position, the reverse roller pair 30b is located rearward of the distal end 156b of the first guide 54b at the first position in the front-rear direction.

The separation distance D2 between the distal end 156b of the conveyance-path forming member 42b of the first guide 54b at the first position and the nip position of the reverse roller pair 45b is set to be less than or equal to the dimension of the long side of the A4-sized sheet 12. Thus, when the sheet 12 is jammed while being nipped by the reverse roller pair 45b, the leading end of the sheet 12 hangs downward, which allows the user to easily find the jammed sheet 12, thereby facilitating jam removal.

Other modifications will be described. In the above-mentioned embodiment, a part of the outer circumferential surface of the pinch roller 23 protrudes from the second guide surface 50 of the first guide 54, and a part of the outer circumferential surface of the re-conveyance roller 22 protrudes from the third guide surface 76 of the rear pivoting unit 74. In other words, the pinch roller 23 and the re-conveyance roller 22 are arranged so that the second guide surface 50 and the third guide surface 76 do not contact each other, but the present disclosure is not limited to this configuration. The first guide 54 may have, for example, a protrusion protruding from the second guide surface 50 so as not to contact the rear pivoting unit 74. The first guide 54 may not have a protrusion, and the third guide surface 76 of the rear pivoting unit 74 may have a protrusion. The second guide surface 50 and the third guide surface 76 may both have protrusions so that the first guide 54 and the rear pivoting unit 74 do not contact each other. The protrusions may be members that have elasticity, such as rubber or silicon.

In the above-described embodiment, the print engine 24 is located between the conveyance roller pair 59 and the discharge roller pair 44, but the present disclosure is not limited to this configuration. The print engine 24 may be located at a position where an image is printed on the sheet 12.

In the above-described embodiment, the first urging member 17 urges the front pivoting member 105 leftward relative to the right side frame 115, but the present disclosure is not limited to this configuration. The first urging member 17 may urge the front pivoting member 105 rightward relative to the left side frame 114. The protruding portion 153 of the front pivoting member 105 may protrude rightward from the surface of the main body 150 facing rightward.

In the above-described embodiment, the first guide 54 pivots about the shaft 31, the rear pivoting unit 74 pivots about the shaft 43, and the front pivoting member 105 pivots about the shaft 69, but the present disclosure is not limited to this configuration. The first guide 54, the rear pivoting unit 74, and the front pivoting member 105 may be moved in the upper-lower direction by a ball screw, for example.

In the above-described embodiment, the slider 103 slides between the seventh position and the eighth position due to the insertion and removal of the feed tray 20, but the present disclosure is not limited to this configuration. The slider 103 may slide between the seventh position and the eighth position by the user's manual operation.

The MFP 10 according to the above-described embodiment may have a scanner function and a facsimile function in addition to an image printing function. Further, the present disclosure may be applied to a printing apparatus having only an image printing function, other than the MFP 10, and the same effects as when applied to the MFP 10 are obtained.

In the above-described embodiment, the case where the front pivoting member 105 is supported by the discharge tray 21 at the ninth position and is not supported by the slider 103 has been described as an example, but the present disclosure is not limited to this configuration. The front pivoting member 105 may be supported by the slider 103 at the seventh position without being supported by the discharge tray 21 at the ninth position.

What is claimed is:

1. A printing apparatus comprising:
a housing;
a first guide located in the housing, the first guide including a first guide surface and a second guide surface, the first guide surface defining a first conveyance path, the second guide surface defining a second conveyance path located below the first conveyance path; and
a second guide located below the first guide, the second guide including a third guide surface defining the second conveyance path,
the first guide being movable between:
a first position at which the first guide surface guides a sheet that is conveyed along the first conveyance path; and
a second position at which the first guide is located at a lower position than the first guide at the first position,
the second guide being movable between:
a third position at which the third guide surface guides a sheet that is conveyed along the second conveyance path; and
a fourth position at which the second conveyance path is opened,
the first guide at the second position being located above the second guide at the fourth position.

2. The printing apparatus according to claim 1, wherein the second guide at the third position supports the first guide; and
wherein the first guide is configured to move to the second position in conjunction with movement of the second guide from the third position to the fourth position.

3. The printing apparatus according to claim 1, wherein the second conveyance path is connected to the first conveyance path at a downstream position and an upstream position, the upstream position being located upstream of the downstream position in a conveyance direction, the conveyance direction being a direction in which a sheet is conveyed along the first conveyance path;
wherein the first guide is configured to move between the first position and the second position by pivotal movement about a first pivot shaft, the first pivot shaft being located at an upstream end of the first guide in the conveyance direction; and
wherein the second guide is configured to move between the third position and the fourth position by pivotal movement about a second pivot shaft, the second pivot shaft being located at a downstream end of the second guide in a reverse conveyance direction, the reverse conveyance direction being a direction in which a sheet is conveyed along the second conveyance path.

4. The printing apparatus according to claim 1, wherein at least the first guide or the second guide includes a protrusion that protrudes from the second guide surface or the third guide surface; and
wherein the first guide and the second guide at the third position contact each other at the protrusion.

5. The printing apparatus according to claim 4, wherein the protrusion is a roller.

6. The printing apparatus according to claim 1, further comprising an engagement portion movable between:
a fifth position at which the engagement portion maintains the second guide at the third position; and
a sixth position at which the engagement portion allows the second guide to move to the fourth position.

7. The printing apparatus according to claim 1, further comprising a slider movable between:
a first slider position at which the slider supports the first guide at the first position; and
a second slider position at which the slider allows the first guide to move to the second position.

8. The printing apparatus according to claim 7, wherein the slider includes a first inclined surface configured to guide the first guide at the second position to the first position when the slider moves from the second slider position to the first slider position.

9. The printing apparatus according to claim 7, further comprising a tray located below the second guide, the tray being configured to be pulled out of the housing,
wherein the slider is configured to move from the first slider position to the second slider position in conjunction with movement of the tray that is pulled out of the housing.

10. The printing apparatus according to claim 9, wherein the slider is configured to move from the second slider position to the first slider position in conjunction with movement of the tray that is pushed into the housing.

11. The printing apparatus according to claim 1, further comprising:
a third guide located upstream of the second guide in a reverse conveyance direction, the reverse conveyance direction being a direction in which a sheet is conveyed along the second conveyance path, the third guide defining the second conveyance path, the third guide being pivotable about a third pivot shaft, the third pivot shaft being located at an upstream end of the third guide in the reverse conveyance direction;
a tray located below the second guide, the tray being configured to be pulled out of the housing; and
a slider configured to move in conjunction with movement of the tray,
wherein the third guide is pivotable between:
a guide position at which the third guide guides a sheet that is conveyed along the second conveyance path; and
an enter position at which the third guide enters the second conveyance path; and
wherein the slider is movable between a first slider position and a second slider position at which the slider supports the third guide at the enter position.

12. The printing apparatus according to claim 11, wherein the third guide is movable along the third pivot shaft;
wherein the printing apparatus further comprises a first urging member configured to urge the third guide toward one side along the third pivot shaft; and
wherein the third guide is configured to move away from the slider by moving toward another side along the third pivot shaft against an urging force of the first urging member.

13. The printing apparatus according to claim 1, further comprising a reverse roller configured to convey a sheet to the second conveyance path,
wherein a distance between the reverse roller and the first guide at the first position is less than or equal to 297 mm.

14. The printing apparatus according to claim 1, further comprising a reverse roller configured to convey a sheet to the second conveyance path,
wherein a distance between the reverse roller and the first guide at the first position is less than or equal to 127 mm.

15. The printing apparatus according to claim 7, further comprising:
a tray located below the second guide, the tray being configured to be pulled out of the housing in a pulling direction and to be inserted into the housing in an insertion direction,
wherein the first guide includes a contact portion protruding downward from the second guide surface;
wherein the slider is movable in the pulling direction and in the insertion direction in conjunction with movement of the tray, the slider including a first cam surface that is a horizontal surface; and
wherein, when the slider is located at the first slider position, the contact portion contacts the first cam surface and the first guide is positioned by the first cam surface.

16. The printing apparatus according to claim 15, wherein the slider further includes a first inclined surface continuous with the first cam surface and located toward the insertion direction with respect to the first cam surface, the first inclined surface sloping downward toward the insertion direction; and
wherein, when the slider moves from the second slider position to the first slider position, the contact portion of the first guide slides on the first inclined surface and moves onto the first cam surface.

17. The printing apparatus according to claim 16, further comprising:
a third guide located upstream of the second guide in a reverse conveyance direction, the reverse conveyance direction being a direction in which a sheet is conveyed along the second conveyance path, the third guide defining the second conveyance path, the third guide being pivotable about a third pivot shaft, the third pivot shaft being located at an upstream end of the third guide in the reverse conveyance direction;
wherein the third guide is pivotable between:
a guide position at which the third guide guides a sheet that is conveyed along the second conveyance path; and
an enter position at which the third guide enters the second conveyance path;
wherein the slider includes:
a second cam surface that is a horizontal surface;
a third cam surface that is a horizontal surface, the third cam surface being located toward the insertion direction with respect to the second cam surface, the third cam surface being located above the second cam surface, the third cam surface being configured to support the third guide when the third guide is located at the enter position; and
an other inclined surface located between the second cam surface and the third cam surface, the other inclined surface sloping upward toward the insertion direction; and
wherein, when the slider moves from the first slider position to the second slider position, the third guide slides on the other inclined surface and moves onto the third cam surface.
